(19) United States
(12) Patent Application Publication
(10) Pub. No.: US 2002/0006790 A1
(43) Pub. Date: Jan. 17, 2002

(54) System and method for remote maintenance and/or remote diagnosis of an automation system by means of electronic mail

(76) Inventors: Werner Blumenstock, Weisendorf (DE); Reiner Plaum, Erlangen (DE); Thomas Talanis, Heroldsbach (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/839,419

(22) Filed: Apr. 23, 2001

Related U.S. Application Data
(63) Continuation of application No. PCT/DE99/03250, filed on Oct. 8, 1999.

(30) Foreign Application Priority Data
Oct. 21, 1998 (DE) 19848618.9.

(51) Int. Cl. H04Q 7/20

(52) U.S. Cl. 455/423; 455/425

(57) ABSTRACT

The invention relates to a system for remote maintenance and/or diagnosis of an automation system (2), which is provided with an electronic firewall (12). To access the automation system, for instance via the Internet from any computer connected to the Internet, it is proposed to transmit an e-mail message (16) to the automation system via a data transmission system (18) with a first transmit/receive device (3) which is disposed at the location of a remote user (1). To this end, an instruction (8) to be executed at the location of the automation system is packaged by an instruction encoder in the e-mail message to be transmitted. At the location of the automation system, a second transmit/receive device (5) is provided to receive the e-mail message sent by the remote user (1). The second transmit/receive device has an instruction decoder (11) to automatically identify the instruction in the e-mail message and forward the instruction to the application (6) for which the instruction is intended.

This is a Continuation of International Application PCT/DE99/03250, with an international filing date of Oct. 8, 1999, the disclosure of which is incorporated into this application by reference.

### FIELD OF THE INVENTION

The invention relates to a system and method for remote maintenance and/or diagnosis of an automation system provided with an electronic firewall via a data transmission system.

### BACKGROUND OF THE INVENTION

For remote maintenance and/or diagnosis, a special data connection is required between an automation system and a remote user intending to perform remote maintenance and/or diagnosis. Due to this special data connection that needs to be provided, remote maintenance and/or diagnosis is associated with high costs. Within corporate communications networks, data connections to an Intranet are frequently, i.e., to an internal corporate data network and/or to a worldwide data network, for instance the Internet. The internal data network is usually protected against the outside by a protective barrier, a so-called firewall, i.e., the data environment within the internal corporate communications network cannot be accessed from outside the internal communications network. If data within the communications network is to be accessed from outside the firewall, a stand-alone computer must normally be installed outside the firewall. U.S. Pat. No. 5,715,393, for instance, discloses a method for remote computer system monitoring via electronic mail.

### OBJECTS OF THE INVENTION

An object of the invention is to provide a system and method for remote maintenance and/or diagnosis of an automation system. It is a further object to provide such a system and method which make it possible to easily provide remote maintenance or remote diagnosis even if an electronic firewall surrounds the automation system.

### SUMMARY OF THE INVENTION

According to one formulation of the invention, the invention is directed to a data transmission system for at least one of remote maintenance and diagnosis of an automation system that is provided with an electronic firewall. The transmission system includes a first transmit/receive device and a second transmit/receive device. The first transmit/receive device is disposed at a location of a remote user that sends a first e-mail message, via a data transmission system, to the automation system. The first transmit/receive device includes an instruction encoder, which packages at least one instruction in the first e-mail message. The second transmit/receive device is disposed at a location of the automation system to receive the first e-mail message sent by the remote user. The second transmit/receive device includes an instruction decoder which automatically identifies the instruction in the first e-mail message, and which transmits the instruction to an application of the automation system for which the instruction is intended.

The invention is based on the realization that access to devices of an automation system is possible even behind an electronic firewall, if the desired control instructions are packaged in an e-mail message. To this end, at the location of a remote user intending to perform remote maintenance or remote diagnosis of an automation system, a desired instruction is packaged into the e-mail message to be transmitted. It is then addressed and sent to the automation system. The addressee within the automation system receives and decodes the e-mail message, that is, the addressee extracts the control instruction from the e-mail message, and forwards it to an application for which the control instruction is intended. This makes it possible for the remote user to initiate commands and, for instance, transmit data for the automation system without the requirement of a separate and costly data connection between the remote user and the automation system. Additionally, the firewall surrounding the automation system does not present an obstacle for the electronic mail.

In analogous fashion to the transmission of the instruction, a reply may be sent to the remote user, in that the second transmit/receive device is provided to accept information, which is determined by the application as a result of the instruction, and to transmit the information in the form of electronic mail to the first transmit/receive device of the remote user. Consequently, the remote user is not only able to control the automation system, but can also request, for instance, status information of the automation system. This renders it possible actually to operate and monitor the automation system from the remote location.

Security against unauthorized penetration of the firewall of the automation system is ensured by an encryption device used to encrypt the information transmitted from the second transmit/receive device to the first transmit/receive device. A decryption device at the location of the remote user is used to decrypt the information. This ensures that only the user possessing the associated key can read, transmit and receive control data to and from the automation system.

### BRIEF DESCRIPTION OF THE DRAWINGS

Other objects and features of this invention will become understood from the following description with reference to the accompanying drawings.

FIG. 1 is a block diagram of an embodiment of a system for remote maintenance and diagnosis of an automation system,

FIG. 2a is an embodiment of the basic structure of an electronic mail message for remote maintenance,

FIG. 2b is an embodiment for the basic structure of a result message, and

FIG. 3 is a schematic representation of a process sequence for remote maintenance and remote diagnosis, according to the present invention.

### DETAILED DESCRIPTION OF THE PREFERRED EMBODIMENTS

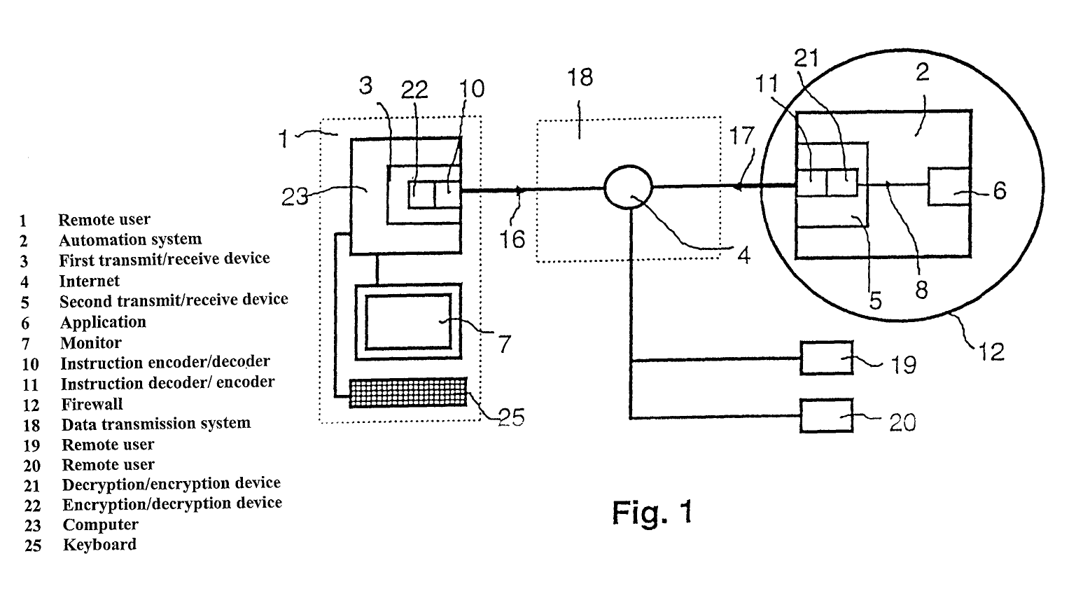

FIG. 1 shows an embodiment of a system for remote maintenance and diagnosis of an automation system via a data transmission system 18. The data transmission system 18 is connected via an Internet 4 with remote users 1, 19, 20 as well as with automation system 2. At the location of the remote user 1, a computer 23 is provided, which has a first transmit/receive device 3. The computer 23 is coupled with a monitor 7 and a keyboard 25. The first transmit/receive device 3 has an instruction encoder 10, which is used to package an instruction in an electronic or e-mail message 16 to be transmitted. In addition to the instruction encoder 10, the first transmit/receive device 3 has an encryption/decryption device 22 to encrypt the instruction that is packaged in the e-mail message 16.

At the location of the automation system 2, a second transmit/receive device 5 is provided for receiving and transmitting electronic messages 16, 17. The second transmit/receive device 5 has a decoder 11 that is used to decode the instruction contained in a received e-mail message 16. An instruction 8, extracted in this manner, is then forwarded via a decryption device 21 to an application 6 for which the instruction 8 is intended. Likewise, it is also possible, according to the present invention, to send information from the location of the automation system 2, in the form of an e-mail message 17 via the Internet 4 of the data transmission system 18, to the remote user 1, 19 and/or 20. At the location of the automation system 2, an electronic firewall 12 is provided, which prevents direct access from the outside to the automation system 2, but which is penetrable for the receipt or transmission of e-mail messages 16, 17.

By means of the system for remote maintenance and/or remote diagnosis of the automation system 2 protected by the electronic firewall 12 as depicted in FIG. 1, simple commands may be executed by the remote user 1, 19 and/or 20 and data may be transmitted from the automation system 2 to the remote user 1, 19 and/or 20. This will now be described in greater detail with the aid of the remote user 1. For remote maintenance and/or diagnosis from the location of the remote user 1, the computer 23 along with the keyboard 25 and the monitor 7 coupled to the computer 23, are used to call up the first transmit/receive device 3, with for instance a correspondingly adapted standard e-mail tool, such as Microsoft Exchange, etc. An address of the automation system 2 is entered in the address field, and the application 6, for which an executable command is intended, is entered in the subject field. The command itself is entered in the text field of the e-mail message and, if desired, is encrypted by the encryption device 22. Encryption ensures that only the automation system possessing an associated key can read the corresponding data.

Subsequently, the composed e-mail message 16 is transmitted via the data transmission system 18, in particular via the Internet 4, to automation system 2. The second transmit/receive device 5, which is part of the automation system 2, receives the e-mail message 16. The transmitted command or instruction is decoded by the decoder 11 and possibly decrypted by the decryption device 21. The command thus obtained is forwarded, for instance, to the application 6 indicated in the subject field of the e-mail message 16, and is executed there. The execution may be for example, in the form of controlling, monitoring or operating the application of the automation system, depending on the format of the instruction. If the e-mail message 16 transmitted by the remote user 1 to the automation system 2 contains, for instance, an instruction 8, which acts as a result generating means and causes a result 9 to be generated in the application 6, the result 9 determined by the application 6 is transmitted in a reverse direction, in the form of the e-mail message 17, to the data transmission system 18 by the second transmit/receive device 5. If appropriate the result data 9 is encrypted by the second encoder 11 and the second encryption device 21. The e-mail message 17 containing the result data 9 of the application 6 is received, decoded and decrypted by the remote user 1. Thus, system shown in FIG. 1 makes it possible to access devices within the firewall 12 by means of so-called e-mail tunneling. Access is possible from any Internet connection, so that, for instance, remote maintenance and/or remote diagnosis of the automation system 2, in case of a malfunction of the automation system 2, is possible irrespective of the location of a specialist.

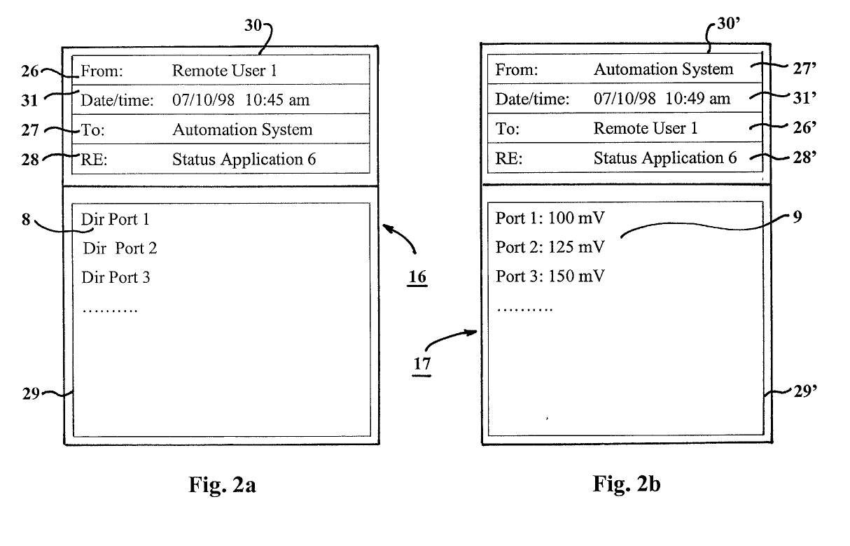

FIG. 2a shows an embodiment of the basic structure of an e-mail message 16, such as it may be displayed, for instance, on the screen of the monitor 7 (compare with FIG. 1). The e-mail message 16 has an identification field 30 and a text field 29. The identification field 30 contains an address field 26, a sender field 27, a date and time field 31, and a subject field 28. The address field 26 serves to indicate the recipient. The sender field 27 identifies the sender, i.e., the remote user sending e-mail message 16. The subject field 28 contains, for instance, a keyword and/or information identifying the special application 6 (compare with FIG. 1) of the automation system. The text field 29 contains the instruction or instructions that are to be transmitted to the application 6.

The structure of the e-mail message 16 shown in FIG. 2a corresponds to the familiar structure of known e-mail tools, such as Microsoft Exchange. This known structure is adapted to the special tasks of remote diagnosis or remote maintenance in that the address field 26 contains the recipient, i.e., the automation system 2, and the subject field 28 contains the special application 6 for which the instruction 8 is intended. As previously mentioned in connection with FIG. 1, the instruction 8 provided in the text field 29 may be encrypted. To generate such an e-mail message for remote maintenance or remote diagnosis, the remote user 1 (compare with FIG. 1) uses a special remote maintenance mail tool, which automatically packages the instructions 8 to be transmitted in the e-mail message 16 using a corresponding instruction encoder (compare with FIG. 1).

FIG. 2b shows the basic structure of a result message 17. The basic structure of the electronic or result message 17 corresponds to that of the electronic or instruction message 16 (compare with FIG. 2a). For instance, result message 17 again has an identification field 30′ and a text field 29′. An address field 26′ in the result message 17 indicates the addressee, for example “remote user 1,” while a sender field 27′ identifies the sender, in this case “automation system 2.” A subject field 28′ contains the information comprised in the subject field 28 of the message 16 sent by the remote user, which is merely supplemented by the addition RE (=answer). The text field 29′ in FIG. 2b contains specific information pertaining to the result message, i.e., status information regarding Port 1, Port 2, Port 3, etc.

The result message 17 depicted in FIG. 2b is automatically generated in the automation system 2 (compare with FIG. 1) in response to the e-mail message 16 transmitted by the remote user 1 and is sent to the remote user 1 by the transmit/receive device 5 of the automation system 2 via the data transmission system 18, in particular the Internet. This makes it possible for a remote user from any location connected to the data transmission system 18 to execute remote maintenance or remote diagnosis. The information contained in the text field 29′ may again be automatically encrypted.

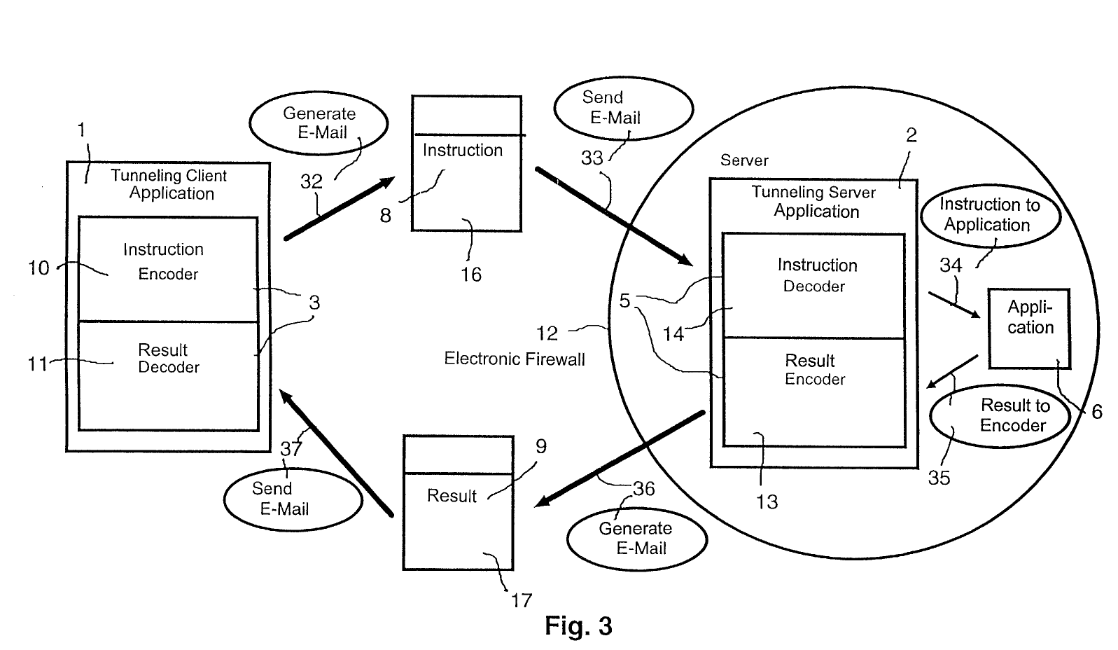

FIG. 3 is a schematic representation of the process sequence for remote maintenance and remote diagnosis. A remote user 1, in a first process step 32 and, using a so-called command or instruction encoder 10, generates an e-mail message 16, which contains a command 8. In a second process step 33, the e-mail message 16, including the corresponding command 8, is sent through a firewall 12 of an automation system 2, for instance on the server of the automation system 2. In a third process step 34, by means of a so-called command or instruction decoder 14, the incoming e-mail message 16 is automatically interpreted and the command 8 thus extracted is forwarded to the corresponding application 6 for execution. A so-called result encoder 13, in a fourth process step 35, accepts the result determined by the application 6, and, in a fifth process step 36, packages it in an e-mail message 17. In a sixth process step 37, the e-mail message 17 is returned to the remote user 1 and the result 9 is extracted from the e-mail message 17 by a result decoder 15 and is displayed to the remote user 1.

In summary, one aspect of the invention thus relates to a system for remote maintenance and/or diagnosis of an automation system 2, which is provided with an electronic firewall 12. To access the automation system 2, for instance via the Internet from any computer connected to the Internet, it is proposed to send an e-mail message 16 to the automation system 2 via a data transmission system 18 with a first transmit/receive device 3 arranged at the location of a remote user 1. To this end, an instruction 8 to be executed at the location of the automation system 2 is packaged by an instruction encoder 10 in an e-mail message 16 to be transmitted. At the location of the automation system 2, there is a second transmit/receive device 5 to receive the e-mail message 16 sent by the remote user 1. This second transmit/receive device 5 has an instruction decoder 11, which automatically identifies the instruction in the e-mail message 16 and forwards this instruction 8 to the application 6 for which the instruction 8 is intended. Another aspect of the invention relates to an associated method that can be carried out by such a system.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications that fall within the spirit and scope of the invention, as defined by the appended claims, and equivalents thereof.

What is claimed is:

1. A data transmission system for at least one of remote maintenance and diagnosis of an automation system, which is provided with an electronic firewall, said system comprising:
a first transmit/receive device disposed at a location of a remote user which sends a first e-mail message, via a data transmission system, to the automation system, wherein the first transmit/receive device includes
an instruction encoder which packages at least one instruction in the first e-mail message; and
a second transmit/receive device disposed at a location of the automation system to receive the first e-mail message sent by the remote user, wherein the second transmit/receive device includes
an instruction decoder which automatically identifies the instruction in the first e-mail message, and which transmits the instruction to an application of the automation system for which the instruction is intended.

2. The system as claimed in claim 1, wherein the instruction sent by the first transmit/receive device is at least one of to control, operate and monitor the application of the automation system.

3. The system as claimed in claim 1, wherein the application comprises a component apparatus of the automation system.

4. The system as claimed in claim 1,
wherein the first e-mail message sent from the first transmit/receive device contains an instruction which is operative to generate result information in the application, and
wherein the second transmit/receive device transmits the result information in the form of a second e-mail message, in a reverse direction, to the first transmit/receive device of the remote user.

5. The system as claimed in claim 1, wherein the second transmit/receive device is configured to receive result information generated by the application and send the result information in a second e-mail message to the first transmit/receive device of the remote user.

6. The system as claimed in claim 5,
wherein the second transmit/receive device further comprises an encryption device which encrypts the result information contained in the second e-mail sent by the second transmit/receive device to the first transmit/receive device; and
wherein the first transmit/receive device further comprises a decryption device which decrypts the result information contained in the second e-mail, at the location of the remote user.

7. The system as claimed in claim 5, wherein the first e-mail and the second e-mail have, respectively, an identification field and a text field.

8. The system as claimed in claim 7,
wherein the identification field includes an address field, a sender field, a date and time field, and a subject field; and
wherein the text field in the first e-mail includes the instruction which is to be transmitted to the application, and the text field in the second e-mail includes the result information sent to the first transmit/receive device.

9. A method for at least one of remote maintenance and diagnosis of an automation system, which is provided with an electronic firewall, the method comprising:
packaging at least one instruction in a first e-mail;
sending the first e-mail, by a remote user via a data transmission system;
receiving the first e-mail sent by the remote user at a location of the automation system,
identifying, automatically, by the automation system, the instruction contained in the first e-mail; and
forwarding the instruction to an intended application of the automation system for execution of the instruction.

10. The method as claimed in claim 9, further comprising:
formatting the instruction of the first e-mail to be for at least one of controlling, monitoring and operating the application of the automation system.

11. The method as claimed in claim 9, further comprising:
generating result information by the application based on the execution of the instruction in the first e-mail; and
sending the result information from the second transmit/receive device in the form of a second e-mail to the first transmit/receive device of the remote user.

12. The method as claimed in claim 11, further comprising:
encrypting the result information sent by the second transmit/receive device to the first transmit/receive device; and
decrypting, at the location of the remote user, the result information received from the second transmit/receive device.

13. A data transmission system for at least one of remote maintenance and diagnosis of an automation system shielded by an electronic firewall, said system comprising:
first transmit/receive means disposed at a location of a remote user for sending a first e-mail message to the automation system, wherein the first transmit/receive means includes
instruction encoder means for packaging at least one instruction in the first e-mail message to be transmitted; and
second transmit/receive means disposed at a location of the automation system for receiving the first e-mail message sent by the remote user, wherein the second transmit/receive means includes
instruction decoder means for automatically identifying the instruction in the first e-mail message, and transmitting the instruction to an application of the automation system for which the instruction is intended.

14. The system as claimed in claim 13,
further comprising a result generating means for generating result information in the application, and
wherein said second transmit/receive means is further for transmitting the result information in the form of an e-mail message to the first transmit/receive means of the remote user.

15. A data transmission system for at least one of remote maintenance and diagnosis of an automation system that has at least one application and that is provided within an electronic firewall, said system comprising:
a first communication device disposed at a location outside the firewall and communicating with the automation system through at least one of a first e-mail message and a second e-mail message, wherein the first communication device comprises:
an instruction processor that at least either (a) packages at least one instruction for the application into the first e-mail message or (b) receives result information generated by the application in the second e-mail message; and
a second communication device disposed at a location inside the firewall and relaying at least one of the instruction and the result information between the first communication device and the automation system, wherein the second communication device comprises:
an instruction processor that at least either (a) receives the at least one instruction for the application in the first e-mail message and (b) forwards the at least one instruction to the automation system, or (a) packages the result information generated by the application into the second e-mail message and (b) transmits the result information in the second e-mail message.
